(19) United States
(12) Patent Application Publication
(10) Pub. No.: US 2016/0037041 A1
(43) Pub. Date: Feb. 4, 2016

(54) ADAPTIVE ILLUMINATION APPARATUS AND METHOD

(71) Applicant: VIVOTEK INC., New Taipei (TW)

(72) Inventors: Li-Shan SHIH, New Taipei (TW); Wen-Yuan LI, New Taipei (TW); Chih-Hung CHANG, New Taipei (TW)

(21) Appl. No.: 14/754,285

(22) Filed: Jun. 29, 2015

(30) Foreign Application Priority Data
Jul. 30, 2014 (TW) 103126089

(51) Int. Cl. H04N 5/235

(52) U.S. Cl. CPC H04N 5/2354; H04N 5/2351; H04N 5/2352

(57) ABSTRACT

Disclosed herein are an adaptive illumination apparatus and an adaptive illumination method. The adaptive illumination apparatus is associated with a target scene and comprises a control module and an illumination module. The control module is configured to generate a command associated with an area included in the target scene.

Specifically, the control module selects the area and determines a scope and a direction associated therewith based on a brightness distribution of the target scene, receives a distance parameter associated with a distance between the area and the illumination module, and indicates said scope, direction and distance parameter in the command. The illumination module, coupled with the control module, is capable of panning, tilting, and zooming. Based on the command, the illumination module performs panning, tilting, or zooming and illuminates the area.

### CROSS-REFERENCE TO RELATED APPLICATIONS

This non-provisional application claims priority under 35 U.S.C. §119(a) on Patent Application No(s). 103126089 filed in Taiwan, R.O.C. on Jul. 30, 2014, the entire contents of which are hereby incorporated by reference.

### TECHNICAL FIELD

The disclosure relates to sense illumination, more particularly to an adaptive illumination apparatus with pan, tilt and zoom (abbreviated to PTZ) functions and an adaptive illumination method.

### BACKGROUND

Video, static-image or surveillance cameras usually have a flash or a light compensation device. Projecting strong light onto a dark scene to be shot is the easiest way to compensate light. By doing so, though the scene becomes brighter, overexposure easily occurs to a portion of the capturing result, which corresponds to an object close to the lens or the light source in the scene. For the light compensation based on infrared (IR) light, a smart IR light technology has been promoted to solve such a problem. However, this technology is carried out by the decrease of intensity of output light so may darken a certain portion of the capturing result, which has a proper exposure.

### SUMMARY

According to one or more embodiments, the disclosure provides an adaptive illumination apparatus associated with a target scene. In one embodiment, the adaptive illumination apparatus includes a control module and an illumination module. The illumination module is coupled to the control module. The control module generates a command. The illumination module, according to the command, pans, tilts or zooms for illuminating an area associated with the command. The area is in the target scene. When generating the command, the control module selects the area according to a brightness distribution of the target scene and defines a scope and direction associated with the area. The control module also receives a distance parameter associated with a distance between the area and the illumination module and indicates the scope, direction or distance parameter in the command.

According to one or more embodiments, the disclosure provides an adaptive illumination method associated with a target scene. In one embodiment, the adaptive illumination method includes the following steps. A command is generated to control an illumination module to pan, tilt or zoom for illuminating an area in the target scene.

When the command is generated, the area is selected according to a brightness distribution of the target scene and a relative scope and direction associated with the area are defined according to the brightness distribution of the target scene. A distance parameter that is associated with a distance between the area and the illumination module is received. In the command, the scope, direction or distance parameter is indicated.

### BRIEF DESCRIPTION OF THE DRAWINGS

The present invention will become more fully understood from the detailed description given hereinbelow and the accompanying drawings which are given by way of illustration only and thus are not limitative of the present invention and wherein:

FIG. 1 is a block diagram of an adaptive illumination apparatus according to an embodiment of the disclosure;

FIG. 2 is a schematic diagram of the operation of the illumination module according to an individual command according to an embodiment of the disclosure; and

FIG. 3 is a flow chart of an adaptive illumination method according to an embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

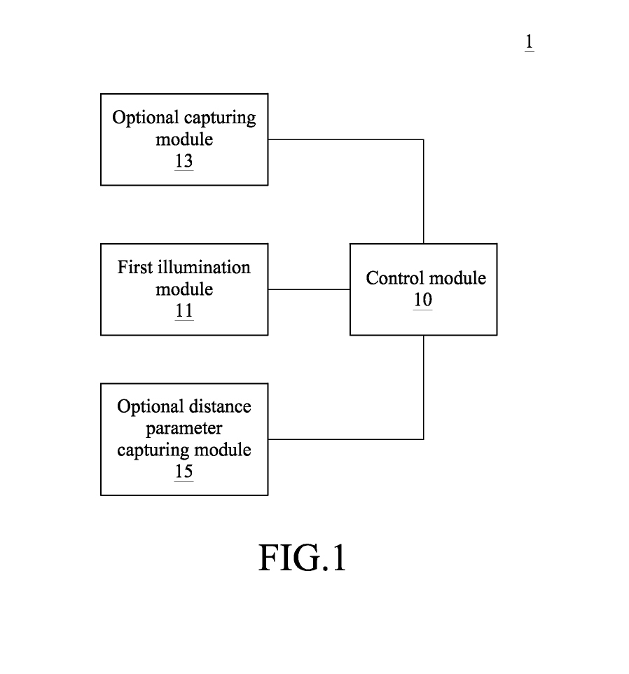

Please refer to FIG. 1, which is a block diagram of an adaptive illumination apparatus 1 according to an embodiment of the disclosure. The adaptive illumination apparatus 1 includes a control module 10, a first illumination module 11, an optional capturing module 13, and an optional distance parameter capturing module 15. The control module 10 is, for example but not limited to, a microcontroller, microprocessor, application-specific integrated circuit, field-programmable gate array, complex programmable logic device, system-on-chip or system-in-package. The illumination module 11 emits light that is, for example but not limited to, infrared light or visible light. The operation of the adaptive illumination apparatus 1 is exemplarily illustrated below.

The control module 10 is coupled with the illumination module 11. The control module 10 generates a first command. The illumination module 11, according to the first command, illuminates a target scene associated with the adaptive illumination apparatus 1.

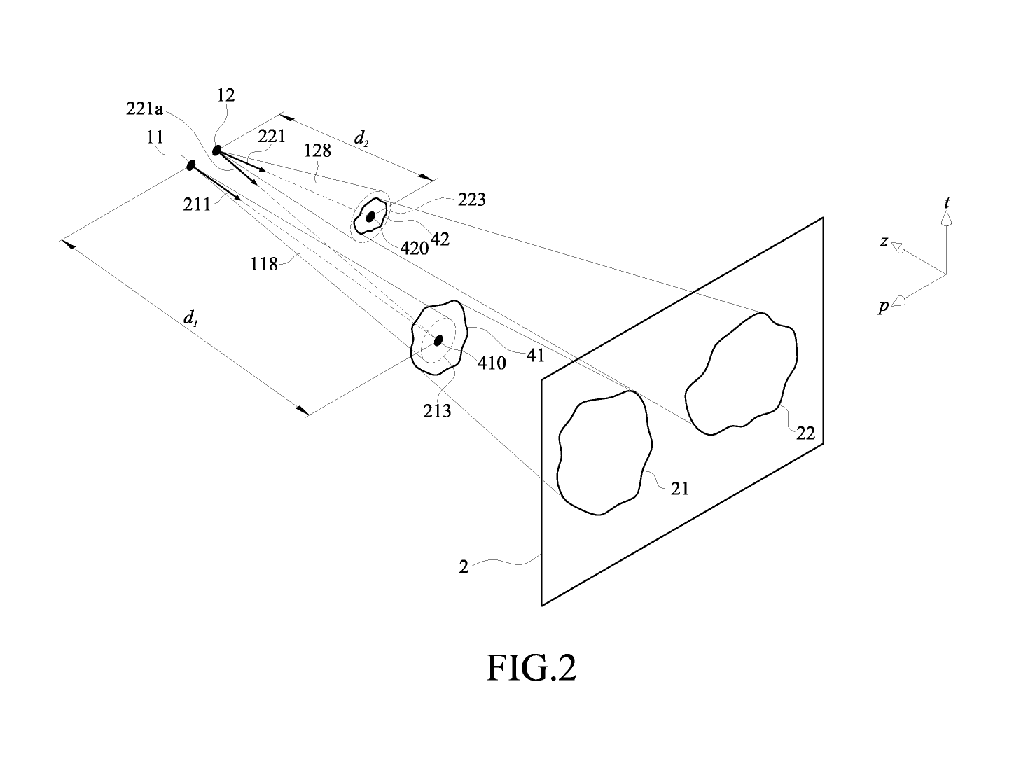

As shown in FIG. 2, the operation of the illumination module 11 is illustrated. The target scene indicates a three-dimensional space (p, t, z) which the adaptive illumination apparatus 1 faces to and a certain external camera or a capturing module 13 can capture images for. The three-dimensional space (p, t, z) can be a Cartesian coordinate system or other possible coordinate systems. For the illumination of the illumination module 11, most of the time the target scene is considered as an imaginary projection plane 2 parallel to the p-t plane. The projection plane 2 is at any location along the z axis. The projection plane 2 associated with the first command includes a first area 21 that is a projection image of a single object 41 or a group of objects 41. In other words, the control module 10 generates the first command for controlling the illumination module 11 to illuminate the object 41, and the control module 10 may make sense of the area 21 rather than the object 41.

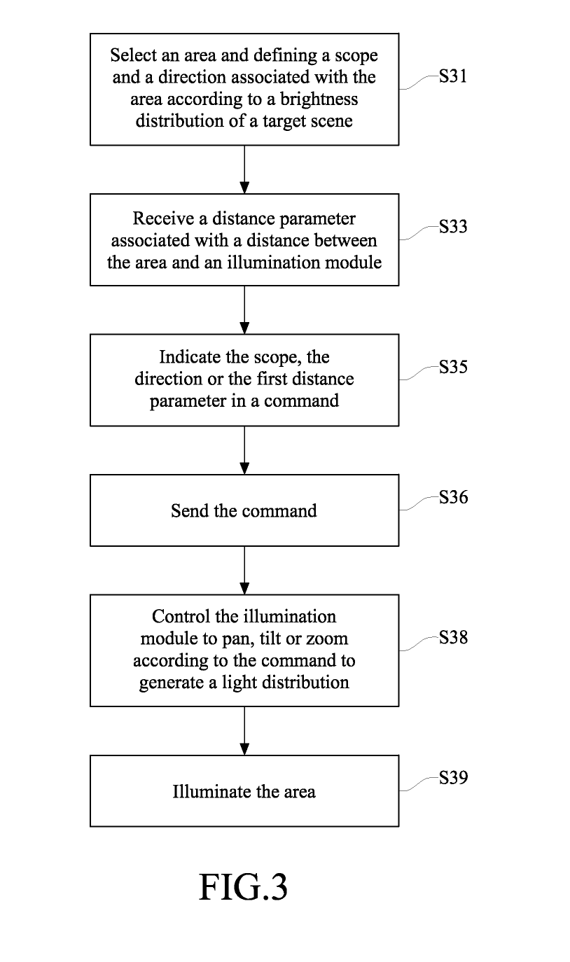

Please refer to FIG. 3, which is a flow chart of an adaptive illumination method according to an embodiment of the disclosure. Generating the above first command by the control module 10 includes steps S31 to S36. In step S31, the control module 10 selects the area 21 according to a brightness distribution of the target scene. The brightness distribution of the target scene is presented by, for example but not limited to, luma values, an image histogram or a color histogram, which is generated by recording brightness of each point or area of the projection plane 2. In an embodiment, the brightness distribution of the target scene can be obtained by acquiring data from an external device such as a luminance meter or a photometer, which records brightness of each point or area of the projection plane 2. In another embodiment, the brightness distribution of the target scene can be obtained by acquiring data from the capturing module 13 that is coupled to the control module 10, functions as a camera to capture images of the target scene, and outputs a digitalized capturing result. The brightness distribution of the target scene is obtained from the capturing result of the capturing module 13 or the control module 10. The adaptive illumination apparatus 1 including the capturing module 13 integrates the illumination function with at least a basic capturing function.

Generally, an area relatively darker than other areas in the projection plane 2 in view of the brightness distribution of the projection plane 2 would make neither the capturing module 13 nor the external camera used by the adaptive illumination apparatus 1 be able to capture great images for the target scene. Therefore, the control module 10 selects such an area as the area 21. In an embodiment, the area 21 is a portion of the projection plane 2, which has a brightness average that is less than a certain threshold. The disclosure has no limitation on how to define or distinguish every portion of the projection plane 2 or how to average values of the brightness distribution.

In step S31, the control module 10 further defines a scope 213 and a direction 211 associated with the area 21. Since the area 21 corresponds to the object 41 in the target scene, the control module 10 commands the illumination module 11 to illuminate in accordance with the shape of the area 21 or the object 41 or in accordance with a portion of the object 41, such as a scope 213 as shown in FIG. 2. In an embodiment, the scope 213 is sufficiently equal to or smaller than an incircle of the contour of the object 41, but the disclosure will not limited thereto. In an embodiment, the direction 211 is a direction from the illumination module 11 to any point on the area 21, and the reference point 410 associated with the object 41 is on the direction 211. In an embodiment, the direction 211 is a direction from the illumination module 11 to the centroid of the area 21 or a point close to the centroid of the area 21.

In step S33, the control module 10 receives a first distance parameter d₁ associated with a distance between any point on the first area 21 (i.e. the object 41) and the illumination module 11. For example, the distance parameter is a length obtained by the laser ranging or is a depth of field in the image processing industry. In an embodiment, the distance parameter is obtained from an external device. In another embodiment, the distance parameter is obtained directly from a distance parameter capturing module 15. The distance parameter capturing module 15 is coupled with the control module 10. In an embodiment, the distance parameter capturing module 15 can detect the distance or the depth of filed and includes at least one or more capturing units. The one or more capturing units can record a depth map corresponding to the projection plane 2 in response to the target scene.

In this embodiment, step S33 follows step S31, the control module 10 receives the distance parameter d₁, and the depth map of the entire target scene may be used. In an embodiment, the capturing module 13 can function as the above capturing unit, and the subsumption and connection relationships between the capturing module 13 and the distance parameter capturing module 15 are not shown in FIG. 1. In this case, the capturing module 13 may directly be coupled with the control module 10. The disclosure has no limitation on the techniques for carrying out the distance parameter capturing module 15. As shown in FIG. 2, the distance parameter d₁ is on an extension line starting passing through the reference point 410 at the direction 211. In an embodiment, the distance parameter capturing module 15 obtains multiple second distance parameters associated with distances between multiple points on the illumination module 11 and multiple points on the object 41 (i.e. the area 21 that is a portion of the target scene) and then averages them to obtain the first distance parameter d₁. In this or some embodiments, the reference point 410 may be on the object 41. The disclosure has no limitation on how to average the second distance parameters and which points on the object 41.

Light projected by the illumination module 11 is efficient and useful in a certain maximum distance. In an embodiment, a maximum distance parameter associated with the maximum distance is stored in the control module 10 in advance. Therefore, when the object 41 is too far from the illumination module 11, the distance parameter d₁ will larger than the maximum distance parameter and then the control module 10 will not generate the first command or will replace the distance parameter d₁ by the maximum distance parameter. In another embodiment, the illumination module 11 directly sets the distance parameter d₁ exceeding the maximum distance parameter to be a new maximum distance parameter.

In step S35, the control module 10 subsumes (indicates) a scope 213, the direction 211 or the distance parameter d₁ in the first command. In step S36, the control module 10 sends the first command to the illumination module 11. In step S38, the illumination module 11 pans in relation to the p axis, tilts in relation to the t axis, or zooms in relation to the z axis to generate a light distribution (also known as light pattern) 118 according to the first command. In step S39, the illumination module 11 illuminates the area 21 or the object 41.

The above direction 211 is associated with the panning and tilting of the illumination module 11, and the above scope 213 and the above distance parameter d₁ are associated with the zooming of the illumination module 11. Since the illumination module 11 includes movable components respectively acting at p, t and z dimensions. The movable component acting at the z dimension can adjust the orientation of the lens (or lens assembly), lampcup or light source of the illumination module 11. In an embodiment, even if the distance parameter is unchanged, the illumination module 11 can still emit light with a light distribution with a different scope by the moving of the movable component at the z dimension. Therefore, the first command will indicate the scope 213 and the distance parameter d₁ simultaneously. In another embodiment, the size of the scope is negatively correlative to the distance parameter. In other words, while the light distribution is convergent more, the projected light travels more far. Therefore, the first command will indicate either the scope 213 or the distance parameter d₁. The light distribution 118 in FIG. 2 has a cone, but the disclosure will not be limited thereto.

In an embodiment, the adaptive illumination apparatus 1 further includes a second illumination module 12 or more illumination modules. In an embodiment, the panable, tiltable and zoomable illumination module 11 can illuminate against a specific area while the illumination module 12 is selectively controlled by the control module 10 to non-directionally and widely illuminate the entire target scene or a certain second area of the target scene. The scope and the distance parameter may negatively be correlative so such wide-illumination can be applied to the object close to the external camera or the capturing module 13. In an embodiment, the illumination module 12 is similar to the illumination module 11 in function and illuminates a second area which is relatively darker, in response to a second command generated by the control module 10. The relative operation of the illumination module 12 can refer to FIG. 3. The first and second areas overlap each other in an embodiment or are the same one in another embodiment but the scope indicated by the first command may be different from the scope indicated by the second command.

For example, as shown in FIG. 2, if the scope 213 cannot cover the object 41, the control module 10 will command the illumination module 12 to deal with the uncovered portion of the object 41. Herein, if the illumination module 11 can not deal with it, the area 21 will still be relatively darker. Therefore, the control module 10 further commands the illumination module 12 to illuminate the object 41 at the direction 221 a.

In an embodiment, the first and second areas respectively correspond to different objects or different groups of objects in the target scene. As shown in FIG. 2, the illumination module 12, according to the light distribution 128, illuminates an object 42 that corresponds to the second area 22 and is separated from the object 41, to fit the second command that indicates the direction 221, the scope 223 and the distance parameter d₂. The direction 221 is from the illumination module 12 to the reference point 420 associated with the object 42. The distance d₂ is shorter than the distance d₁. The scope 223 is sufficiently equal to or slightly larger than a circumcircle of the contour of the object 42. This is one of the schemes for the control module 10 to a closer object, e.g. the object 42. In an embodiment, the control module 10 usually controls the illumination module 11 to illuminate in a far distance and controls the illumination module 12 to illuminate in a near distance. In an alternative embodiment, the control module 10 usually controls the illumination module 12 to illuminate in a far distance and controls the illumination module 11 to illuminate in a near distance. The differences between the first and second commands may relate to the differences in function or performance between the illumination modules 11 and 12 in an embodiment.

In an embodiment, the adaptive illumination method is performed with an automatic exposure (AE) algorithm. For example, the illumination module 11 or 12 is illuminating until this algorithm can perform the post-process to captured images. Alternately, during the pretreatment process, this algorithm may deal with no existence of any useful or meaningful distance parameter or brightness distribution caused by the overexposure or underexposure output of the capturing unit or capturing module when light compensation is not adaptive or has not been performed yet. That is, the AE algorithm adjusts the output of the capturing unit or capturing module. Then, a useful or meaningful distance parameter or brightness distribution can be obtained.

In view of the foregoing embodiments, the disclosure employs an illumination module with PTZ functions to adaptively illuminate a target scene. Adaptive illumination is based on a brightness distribution of the target scene and a distance parameter associated with the brightness distribution of the target scene. Illuminating the target scene is based on the functions of the above components in the adaptive illumination apparatus.

What is claimed is:

1. An adaptive illumination apparatus, associated with a target scene and comprising:
a control module for generating a first command that is associated with a first area in the target scene; and
a first illumination module coupled with the control module, comprising panning, tilting and zooming functions, and configured to pan, tilt or zoom for illuminating the first area according to the first command;
wherein generating the first command comprises:
selecting the first area and defining a scope and a direction associated with the first area according to a brightness distribution of the target scene;
receiving a first distance parameter associated with a distance between the first area and the first illumination module; and
indicating the scope, the direction or the first distance parameter in the first command.

2. The adaptive illumination apparatus according to claim 1, further comprising: a distance parameter capturing module coupled with the control module and configured to obtain the first distance parameter.

3. The adaptive illumination apparatus according to claim 2, wherein the distance parameter capturing module comprises at least a capturing unit for capturing images of the target scene, and the distance parameter capturing module obtains the first distance parameter through the capturing unit.

4. The adaptive illumination apparatus according to claim 1, further comprising: a capturing module for capturing images of the target scene.

5. The adaptive illumination apparatus according to claim 4, wherein the control module is coupled with the capturing module and obtains the brightness distribution by the capturing module.

6. The adaptive illumination apparatus according to claim 1, wherein when a brightness average of an area in the target scene is less than a threshold, the control module selects the area as the first area.

7. The adaptive illumination apparatus according to claim 1, wherein the first distance parameter is an average of a plurality of second distance parameters, and the plurality of second distance parameters is associated with a portion of the target scene covered by the first area.

8. The adaptive illumination apparatus according to claim 1, wherein when the first distance parameter is not larger than a maximum distance parameter, the control module generates the first command.

9. The adaptive illumination apparatus according to claim 1, wherein when the first illumination module, according to the first command, pans, tilts or zooms, the first illumination module pans, tilts or zooms according to the scope, the direction and the first distance parameter to generate a light distribution for illuminating the first area.

10. The adaptive illumination apparatus according to claim 1, further comprising:
a second illumination module coupled with the control module and configured to illuminate a second area in the target scene according to a second command,
wherein the second area is different from the first area, and the control module is further configured to generate the second command.

11. An adaptive illumination method, associated with a target scene and comprising:
generating a first command for controlling an illumination module with panning, tilting and zooming functions to illuminate a first area in the target scene, wherein generating the first command comprises:
selecting the first area and defining a scope and a direction associated with the first area according to a brightness distribution of the target scene;
receiving a first distance parameter associated with a distance between the first area and the illumination module; and
indicating the scope, the direction or the first distance parameter in the first command; and
controlling the illumination module to pan, tilt or zoom for illuminating the first area according to the first command.

12. The adaptive illumination method according to claim 11, wherein when a brightness average of an area in the target scene is less than a threshold, the area is selected as the first area.

13. The adaptive illumination method according to claim 11, wherein the first distance parameter is an average of a plurality of second distance parameters, and the plurality of second distance parameters is associated with a portion of the target scene covered by the first area.

14. The adaptive illumination method according to claim 11, wherein when the first distance parameter is not larger than a maximum distance parameter, the first command is generated.

15. The adaptive illumination method according to claim 11, wherein controlling the illumination module to pan, tilt or zoom according to the first command comprises:
controlling the illumination module to pan, tilt or zoom to generate a light distribution, to illuminate the first area according to the scope, the direction and the first distance parameter.

16. The adaptive illumination method according to claim 11, further comprising:
generating a second command and illuminating a second area in the target scene according to the second command, wherein the second area is different from the first area.
